(19) United States
(12) Patent Application Publication
(10) Pub. No.: US 2007/0279160 A1
(43) Pub. Date: Dec. 6, 2007

(54) Securing means for an access control device

(75) Inventor: Max Schmid, Wangs (CH)

Correspondence Address: BUCHANAN, INGERSOLL & ROONEY PC, POST OFFICE BOX 1404, ALEXANDRIA, VA, 22313-1404, US

(73) Assignee: Elesta relays GmbH, Bad Ragaz (CH)

(21) Appl. No.: 11/806,421

(22) Filed: May 31, 2007

(30) Foreign Application Priority Data
Jun. 1, 2006 (CH) 00881/06

(51) Int. Cl. H01H 75/00; H01H 73/00

(52) U.S. Cl. 335/7; 335/18

(57) ABSTRACT

A securing means is used for keeping closed and releasing, as well as monitoring the state of a part which clears or blocks access to a hazard space. The securing means comprises an electromagnet and an armature for closing the magnetic circuit of the electromagnet. Furthermore the securing means comprises a power supply circuit in which a transistor for connecting a voltage source to the magnetic coil and for separating the voltage source from the magnetic coil and a measuring resistor are present. Furthermore it comprises an evaluation device for measuring the voltage drop over the measuring resistor and for evaluating this current measurement. Because the measuring resistor is also located in the magnetic coil circuit, a coil current can be measured which occurs simply within the coil circuit. Therefore it can be monitored using this current whether during operation the armature is lifted off the core; this induces a current rise in the coil circuit. It can therefore be monitored how the current drop proceeds when the coil is separated from the voltage source. By monitoring the current behavior when the coil is connected to the voltage source and by monitoring the coil circuit for an induced current rise and/or current drop outside of a tolerance region when the voltage source is separated from the coil reliable detection of the state of the securing means is ensured.

### RELATED APPLICATIONS

This application claims priority under 35 U.S.C. §119 to Swiss Application 00881/06 filed in Switzerland on Jun. 1, 2006, the entire contents of which are hereby incorporated by reference in their entireties.

### TECHNICAL FIELD

The disclosure relates to a device and a process for protection against hazardous entry in a hazard space.

Hazard spaces, for example a sealable space of a fabrication facility with a machine in operation in this space which is dangerous to an individual can be able to be made accessible and inaccessible. Access to such a hazard space generally takes place through a door, or other part which clears or blocks the access path. Various securing means have been suggested for monitoring the state of such a door which clears or blocks the access path. A securing means can keep the door itself closed and monitor it, or can keep a lock which locks the door locked and can monitor it.

The disclosure relates especially to such a securing means for an access control device which applies both a closing force to the part which blocks or clears the access path, therefore for example a door or a lock, and also monitors the state of this part.

### BACKGROUND INFORMATION

DE 103 39 363 discloses an access control means for a region of a space. This means can be turned on and off in a controlled manner. It comprises a stationary part and a movable part. With the movable part the access opening in the stationary part can be closed. For the movable part there is a securing means. On the stationary part there is an electromagnet, on the movable part there is an armature with which the electromagnet can be closed. The closing force of the electromagnet can be controlled via current control.

In order that a separate sensor not be required for monitoring the electromagnet, or the position of the armature relative to the electromagnet, a sudden control change from a first given setpoint to a second given setpoint of the current control is done. In this connection, the time from the start of the sudden control change until the second setpoint is reached is measured. If this time interval is larger, the armature is moved farther away, but if it is smaller, the armature is nearer the electromagnet.

The voltage drop is measured over a shunt in the supply line in the means. The voltage on this shunt constitutes a measure of the current flowing through the magnetic coil. This voltage is displayed via an A/D converter.

Based on the above cited principle it must be deduced that the setpoints are within the saturation region of the magnet.

If the electromagnet were to be monitored in the unsaturated region, the correspondingly reversed principle would be used. But in the device as claimed in the invention there is no monitoring of whether the magnet is in fact operated in or outside of saturation. Therefore the measured signal is ambiguous. The ascertained current rise can specifically also occur when there is an air gap (compare FIG. 10).

### SUMMARY

A securing means or an access control device is disclosed for a hazard space with such a securing means.

Such a securing device is used for keeping closed and releasing, as well as monitoring the state of a part which clears or blocks access to a hazard space. An access control device with such a securing means is used to protect against entry into the hazard space at a dangerous time.

The securing means comprises an electromagnet and an armature for closing the magnetic circuit of the electromagnet. In this connection the armature and the electromagnet can be or are located at the access and on the part which clears or blocks access. This arrangement can be such that in the position of this part which denies access the magnetic circuit is closed by the armature, in the position which clears access the magnetic circuit is however open. Furthermore, the securing means comprises a supply circuit in which there are a switch for connection of the power source to a magnetic coil and for separating the current source from the magnetic coil and a measuring resistor. Furthermore, it comprises an evaluation device for measuring the voltage drop over a measuring resistor and for evaluating this current measurement.

The securing means is characterized as disclosed in that the measuring resistor is located both in the supply circuit and also in the magnetic coil circuit.

Its arrangement in the supply circuit allows monitoring of the current behavior during supply of the electromagnet with current from the power supply, therefore when it is being turned on and after it is turned on.

Its arrangement in the magnetic coil circuit allows monitoring of the current behavior when the power supply is being turned off and during which the power supply is off. It furthermore allows recognition of the current rise in the magnet coil circuit as a result of the raising of the anchor off the core.

Advantageously the evaluation device is connected to the operating and display device and a coordinated control for the hazard space and is made for sending information to the operating and display device and for receiving information from the operating and display device. When there is no danger in the hazard space, therefore for example the machine located in it is not operating, the higher-order control is set such that access can be cleared and the operating and display device indicates this. At this point the evaluation device controls the switch such that the armature can be raised off the core without special exertion of force. If it is however dangerous to enter the hazard space, the higher-order control is set such that the evaluation device controls the circuit such that the armature can be released from the core only with special expenditure of force, and the operating and display device indicates this. In this connection, this state of the armature which closes the magnetic circuit is checked. If this state should not be recognized as closed for some reason, via the evaluation device and coordinated control a hazard to an individual entering the hazard space is averted for example by turning off or stopping the machine present therein and is indicated by the operating and display device. With the operating and display device the coordinating control can be influenced in order to stop the dangerous processes in the hazard space and to clear the hazard space or close it and start the dangerous processes.

To monitor the state of the securing means the evaluation device is advantageously made to trigger a switch depending on a time measurement or depending on a value or a value difference of the current measurement. This allows power supply with the switch to be briefly interrupted and thus generate current behavior which is characteristic for the current state in the magnetic coil circuit and to distinguish it from current behavior which is characteristic for another state. The current drop and/or the current rise can be measured using the change of the voltage drop over the measuring resistor.

Advantageously the evaluation device is made such that with it the time behavior of the current rise in the magnetic coil circuit can be measured when the electromagnet is turned on. The time behavior within the unsaturated operating region of the electromagnet is of special interest, since the values measured in this region can be unambiguously assigned to the state of the securing means. Here it is important that using these measured values it can be deduced whether the magnetic circuit is closed or not. If the magnetic circuit is closed, the current in the coil circuit rises to the boundary value of the coil current between the saturated and unsaturated state of the magnet more flatly than with the magnetic circuit opened. In the monitoring of this rise the boundary value can be recognized and assigned to saturated or unsaturated operation based on this boundary value.

It is furthermore advantageous if the evaluation device is made such that the current change during operation of the electromagnet can be measured. It is of special interest to monitor whether the current in the magnetic coil circuit rises beyond the normal level of the operating current. If it does, based on this induced current a change of the location of the armature to the core can be deduced. If the closed state is assumed, this current can only be induced by raising the armature. This evaluation can advantageously lead to terminating the processes engendering the danger in the hazard space by the corresponding control of the evaluation device and coordinated control.

The evaluation device can be configured such that when the supply circuit is interrupted the time behavior of the current drop in the magnetic coil circuit is measured, and that the power supply is turned on again after reaching a measurement value (in time or the current in the magnetic coil circuit) with the switch. Due to the monitoring of the current drop and ascertaining a current which lies above or below the boundary value, the coil can be placed under voltage again depending on this value and the current rise in the unsaturated or saturated operating region of the magnet can be established.

Advantageously however only the slope of the current drop is established. The power supply can be interrupted for example for a fixed time interval. The time can also be measured which passes until the current has dropped to a given value after current interruption in the coil circuit. If the ascertained slope is within a tolerance range the operation of the magnet is in the saturated region. If the current drop is too steep, the magnetic circuit is not closed.

In order to achieve interruption times as short as possible, the core of the electromagnet can be built from transformer laminations.

Furthermore, on the armature side of the electromagnet there can be a control and/or a display. It can be operated without its own power supply by its being supplied with current by induction. For this purpose there is advantageously a coil around the armature and operating electronics connected to the armature coil for input of signals into the magnetic circuit and thus into the magnet coil circuit. These signals can be recognized by the evaluation device and accordingly converted. For display of state changes or of the state of the magnetic circuit there can be display electronics connected to the armature coil. The energy required for this purpose is induced in the armature coil by a current fluctuation which is generated at regular intervals in the magnetic coil circuit and by the fluctuations achieved thereby in the magnetic field of the electromagnet. These current fluctuations are formed by turning the power supply on and off. In these supply interruptions the state of the securing means is checked.

In order to prevent manipulation of the securing means by which a closed magnetic circuit is achieved without an armature, the armature and the core are made with mutually corresponding mating shapes. These mating shapes can be made to differ from a plane. For example three elevations in the core to which three depressions in the armature fit can be configured. In this way a metal part which closes the magnetic circuit can be located simply at the distance of the height of the elevations on the core; this would be recognized as not closed by the evaluation device.

Thus the disclosure also includes monitoring of the state of an access to a part which clears or blocks a hazard space with such a securing means. In this connection, in the conventional manner a change of the voltage drop over the measuring resistor when a supply parameter changes is measured and interpreted. Due to the arrangement of the exemplary measuring resistor as disclosed within the magnet coil circuit, it has now become possible to monitor the time behavior of the current intensity which can be monitored only within the magnet coil circuit. This monitoring has the advantage that the state of the securing means is also recognized when the power supply is briefly turned off. This in turn makes it possible to monitor whether the magnet is located inside or outside the saturated operating range so that the measurement results can be unambiguously assigned to the state of the securing means.

In order to obtain unambiguous results, e.g., the time behavior of the current rise in the magnet coil circuit which occurs when the magnetic coil is connected to the supply circuit is monitored within the unsaturated operating region. If necessary, based on the change of the measured slopes of the current rise, a boundary value of the magnetic coil current with respect to the saturated and unsaturated operating range of the magnet can be determined. This boundary value can be used when the power supply is being turned off to detect when the magnet again reaches the unsaturated region. Advantageously the magnetic coil circuit is separated from the power supply at time intervals and in doing so the current drop in the coil circuit is monitored. As soon as the magnetic coil current drops below a predetermined value which can be above or below the boundary value, the power supply can be turned on again in order to monitor the current rise and ascertain the state of the securing means using the slope of the current rise. Advantageously moreover during operation of the electromagnet the current in the magnetic coil circuit is monitored. If a rise beyond the normal operating level should be ascertained, advantageously a process is triggered which constitutes the matched reaction to the ascertained, forced opening of the part which blocks access to the hazard space.

In the operation of the securing means it can therefore first be recognized whether the magnetic circuit is closed or not when the voltage source is turned on. The time behavior of the current in the coil circuit is an unambiguous measure of this. It can therefore be ascertained within a few milliseconds after the securing means is turned on whether the armature is closing the magnetic circuit.

Therefore it can then be assumed that the magnetic circuit is closed and therefore the armature is held on the core with the maximum magnetic force. Under these assumptions it can simply be monitored whether the armature is being raised or whether the magnet is being operated in the saturated operating region. Both can also be monitored.

To monitor whether the armature is being raised, it is monitored with the evaluation electronics of the coil circuit whether the coil current is rising. If the coil current is rising, during which operation should be continuous, the current rise can originate solely from induction which has been caused by the raising of the armature.

To check whether the magnet is being operated in the saturated state, only the current drop which occurs during interruption of the current supply in the coil circuit need be measured. This measured value gives an unambiguous result within a few milliseconds.

These two monitoring measurement can only be taken when the current in the coil circuit can be measured.

The exemplary device works as follows. With the magnetic circuit closed (small air gap S), the magnetic coil reacts slowly to a voltage change. By repeated or continuous measurement of the magnetic coil current by means of measuring the voltage drop over the measuring resistor, this slow behavior can be clearly distinguished from the almost undelayed behavior of the current when the magnetic circuit is opened. This measurement is first taken following the current supply to the magnetic coil being turned on, especially as long as the magnet is not yet being operated in the saturated state. It can be stated based on this measurement whether the magnetic circuit is closed. When the magnetic circuit is not closed, an alarm takes place and the coordinated control prevents a dangerous process from starting in the hazard space. When the magnetic circuit is closed, the part which blocks access to the hazard space is kept in the blocking position with the entire magnetic force. The coordinated control thereupon releases the start of the dangerous process.

During operation of the dangerous process in the hazard space the securing means can monitor whether access remains blocked. There are two possibilities for entering the hazard space. In any case the armature is released from the core. If the core is in the saturated operating region, the armature can be released from the core against the magnetic force.

The first possibility consists in forcing access by the armature being released from the core against the magnetic force. Since in a forced opening of the door which blocks access the armature, for example due to the resilient mounting, suddenly breaks loose from the core, a clearly measurable current rise is induced by this movement of the armature in the magnetic coil. This additional current can deliver the feed. It is determined using the voltage drop over the measuring resistor located in the coil circuit.

A second possibility consists in the magnetic force not having stayed maintained for some reason. In this case the magnet is no longer operated in the saturated region. It is therefore sufficient to ascertain whether the magnet is being operated in the saturated region or not. In the saturated operating region the time behavior of the current drop after interruption of the power supply is within the known tolerance ranges. Therefore the power supply is briefly separated from the magnetic coil for monitoring the state of the securing means.

If the current drop is outside the tolerance region, securing is not reliably guaranteed, therefore the coordinated control stops the dangerous processes. If the current drop is within the tolerance range and the current intensity of the magnetic coil current is at the required level, the magnet operates in the saturated region. It can be deduced therefrom that the armature is closing the magnetic circuit and therefore access is blocked. The current measured after turning off the power supply circulates through the diode in the magnetic coil circuit. It can only be measured within this circuit.

### BRIEF DESCRIPTION OF THE DRAWINGS

The disclosure is detailed below using the examples illustrated with the drawings.

FIG. 1 schematically shows an exemplary access control device with a securing means;

FIG. 2 schematically shows the securing means;

FIG. 3 schematically shows an exemplary access control device with a securing means, equipped with armature-side operating electronics;

FIG. 4 schematically shows the securing means with armature-side operating electronics;

FIG. 5 diagrammatically shows an exemplary behavior of the current in the magnetic coil circuit relative to the time for different air gap widths, when the power supply is turned on and off, and when the armature is raised off the core,

FIG. 6 shows a diagram of the current behavior and the voltage behavior in the coil circuit when the power supply is turned on, off and on again;

FIG. 7 shows an exemplary diagram of the current rise in the magnetic coil circuit over two given time intervals depending on the air gap width;

FIG. 8 shows an exemplary diagram of the slope of the current rise in this time interval;

FIG. 9 shows an exemplary table with measured values of the current in the magnetic coil circuit for different air gap widths and depending on different time intervals after the power supply is turned off;

FIG. 10 shows an exemplary comparison of the measurement results for the rise of the flux density B relative to the rise of the magnetic field strength H in the saturated region of the magnet for different core materials.

### DETAILED DESCRIPTION

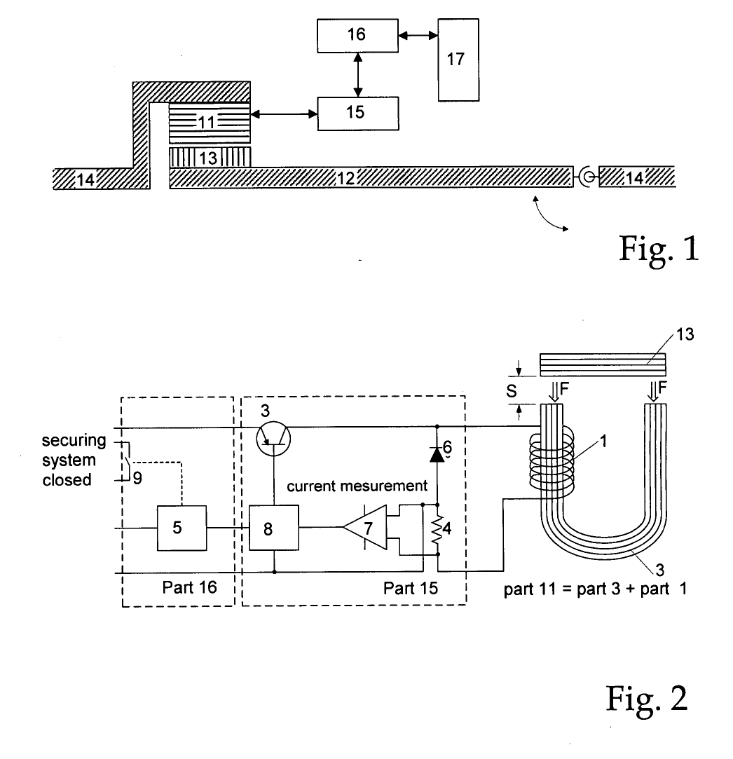

In the exemplary access control device shown in FIG. 1, the wall between the outside and the hazard space is labelled 14. The access opening in the wall 14 is closed with a door 12. On the wall there is a magnet 11. On the door there is an armature 13. The magnet 11 and the armature 13 fit one another so that the armature closes the magnetic circuit of the electromagnet 11 when the door 12 closes the access opening in the wall 14. The door however can also be pivoted by its hinges so that it can release access to the hazard space. When the door opens the armature is necessarily raised off the core of the electromagnet. Thus the magnetic circuit is then opened. Control electronics 15 for the magnet are connected to the electromagnet 11. These control electronics 15 are connected to the operating and display electronics 16 which are in turn connected to a coordinated control 17.

FIG. 2 shows an exemplary electromagnet 11 with the core 3, coil 1, and armature 13, as well as the control electronics 15. The control electronics 15 consist of adding to the magnetic coil circuit a diode 6 and a measuring resistor 4, power supply lines for power supply of the magnetic coil 1, and measurement electronics 7 for measuring the current in the coil circuit based on the voltage drop over the measuring resistor 4. Furthermore, the control electronics comprises a microcontroller 8 and a transistor 2.

The operating and display electronics 16 is connected to the control electronics 15. To display the state of the securing means 11, 13, i.e. to indicate whether there is no air gap or there is a large air gap S between the armature 13 and the core 3, a contact is closed by the operating and display electronics if the air gap can be ignored and the magnetic force F on the armature is large, or opened when the air gap s is large. A signal light can be connected to this contact.

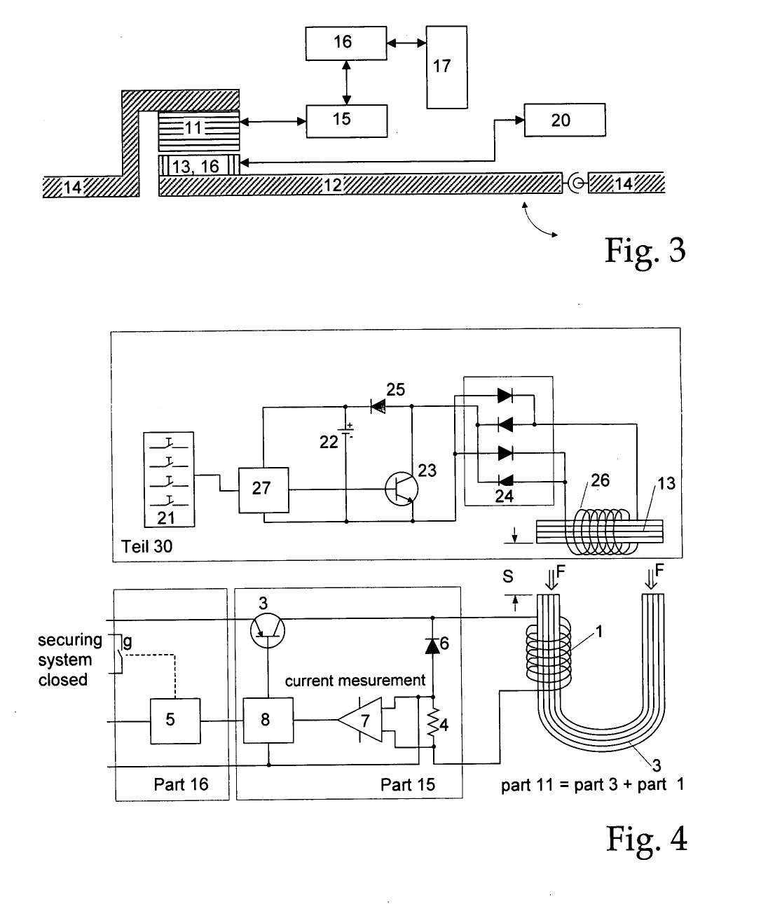

In FIGS. 3 and 4 operating and display electronics 20 are added to the securing means on the armature side of the electromagnet. The armature 13 is provided with an armature coil 26. An electronic circuit is connected to the armature coil and can both detect the signals induced in the armature coil 26 and can also deliver signals to the armature coil 26 which can then be detected and evaluated by the control electronics 15.

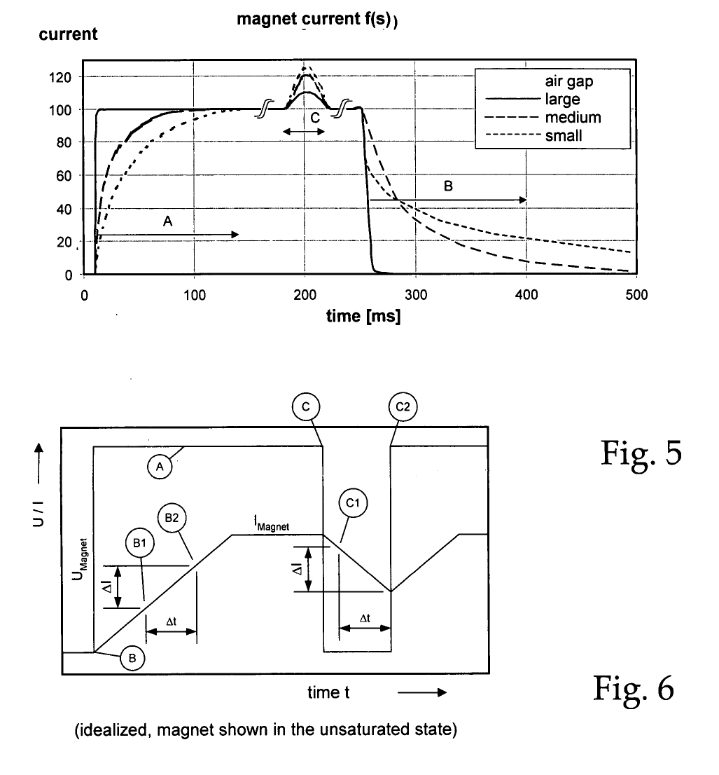

FIG. 5 shows an exemplary time behavior of the current in the magnetic coil 1 depending on the air gap width S between the core 3 and the armature 13. In the region A which in the example is during the first roughly 150 milliseconds, the behavior after turning on the power supply at instant 0 is shown. For a small air gap the current rises more slowly than for a large air gap. The curve then approaches a peak, here 100 mA. This peak is reached more quickly, the larger the air gap. In the region B the current behavior is shown when the power supply is being turned off. The curves quickly descend in the saturated region of the magnet. If the magnetic circuit is open, the current drops immediately. If the magnetic circuit is closed, the current decreases slowly.

In the region C a current rise is shown which occurs when the armature is released from the core against the magnetic force F. This movement of the armature away from the magnetic circuit allows the coil current to rise. The more closed the magnetic circuit in the initial position, the greater the induced current rise becomes.

The exemplary diagram shown in FIG. 6 shows in an overlapped representation on the one hand the voltage U which is delivered to the magnetic coil circuit as a rectangular wavy line, the currents triggered in the magnet as rising and falling ramps on the time axis. It is an idealized representation within the unsaturated operating region of the magnet. At time B the voltage U_{Magnet} is turned on. This voltage rises directly to its maximum value and thus triggers a rise of the current in the magnetic coil. It rises up to a maximum value which is labelled here I_{magnet}. At time C the power supply is turned off. The voltage immediately collapses to 0. The current drops up to the instant C2 at which the power supply is turned on again and the current therefore rises again.

The slope of the current behavior between the measurement instants B1 and B2 as well as C1 and C2 can be indicated with ΔI by Δt.

This rise in the region B1 to B2 is dependent on the air gap width S between the armature and core. In FIG. 7 this current rise is plotted as a function of the air gap width S which takes place within the first 20 milliseconds (solid line) or within a time window of 10 to 20 milliseconds (broken line) after the power supply is turned on. The graphics show that the rise is a measure for the gap width. The rise is therefore steeper, the wider the air gap.

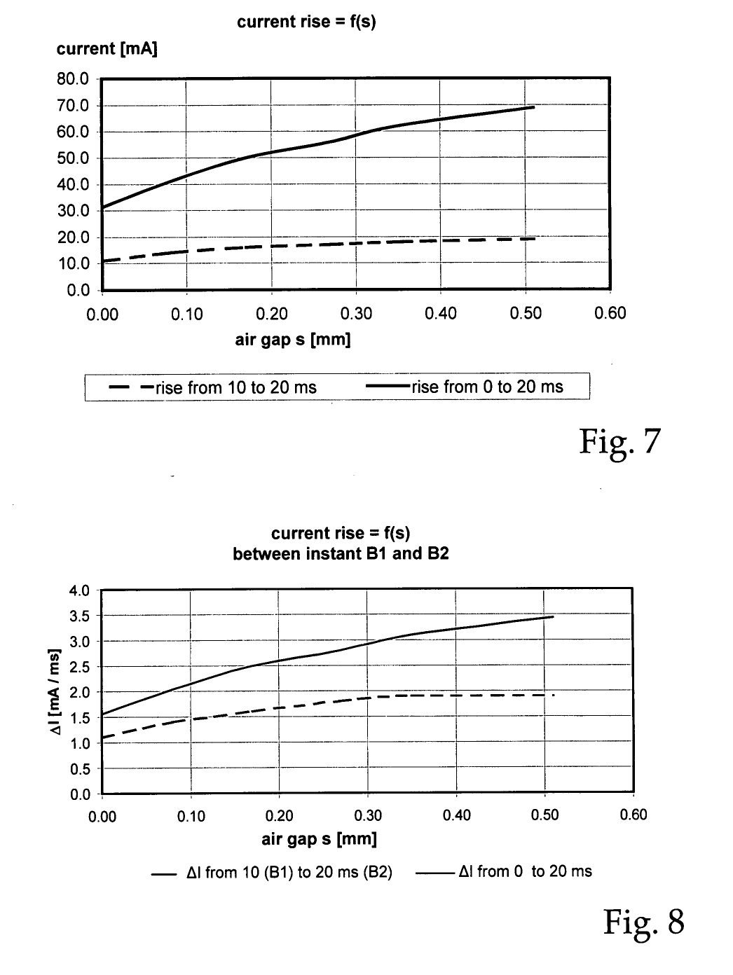

FIG. 8 shows an exemplary slope of the rise. The x axis contains the air gap width in mm as in FIG. 7. The y axis however in contrast to FIG. 7 contains the ratio current rise per millisecond. This representation shows that the average slope in the region from 10 to 20 milliseconds is flatter (broken line) than in the region 0 to 20 ms (solid line).

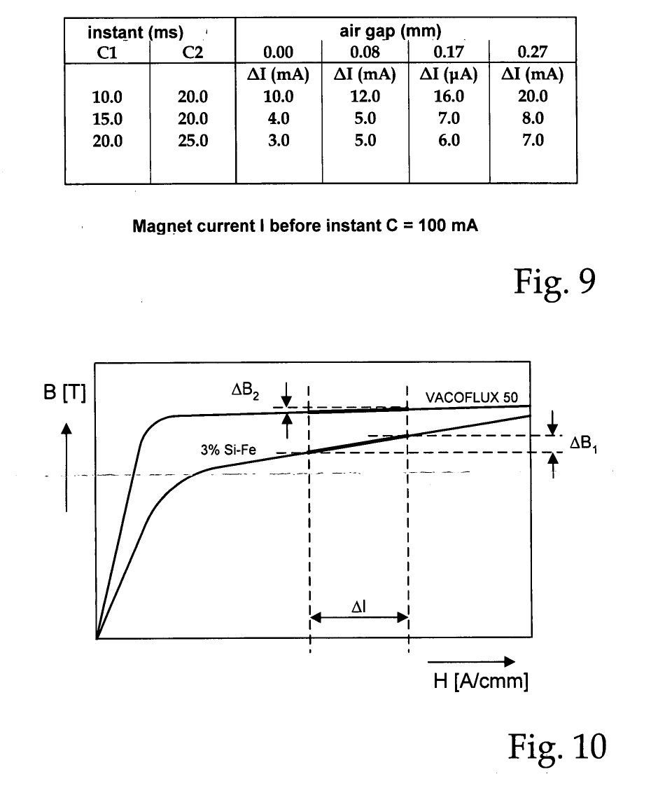

In the exemplary table as shown in FIG. 9 the current drop between the instants C1 and C2 is shown. A current of 100 mA at time C (FIG. 6) is shown. The current drop in the unsaturated region of the magnet according to the table is greater, the wider the air gap. It is smaller, the later after turning off the voltage source the current drop is measured.

FIG. 10 shows that the increase of an exemplary magnetic flux in the saturated region is very flat and very highly dependent on the material. A current change of ΔI in the material “Vacoflux 50”™ compared to soft iron produces a distinct deviation in the increase of the flux density B.

If however the air gap is open to a certain extent (flat lower curve) a very similar rise of the curve takes place. The current rise alone can therefore not be unambiguously interpreted. The current rise within the unsaturated region for a certain air gap is therefore identical to the current rise when the magnetic circuit is closed in the saturated region.

In the unsaturated operating region (near the y axis) it can however be very clearly distinguished using the coil behavior whether the air gap is large or small.

The device as shown in FIGS. 3 and 4 is therefore operated for example as follows. The door 12 is closed. In the hazard space the dangerous process will be started. The microprocessor (evaluation electronics) 8 of the control electronics 15 ultimately receives from the coordinated control 17 the information that the hazard space will be accessible. The evaluation electronics 8 turns on the power supply to the magnetic coil circuit with the transistor 2 at regular intervals for a few milliseconds. The current change causes a magnetic field change which causes a current change in the coil circuit of the armature coil 26. With this current change the operating and control electronics 20 on the armature side are supplied. The electronics show the operating state. For example, a green light emitting diode lights which indicates that access to the hazard space has been cleared.

With for example the armature-side operating and display electronics the responsible worker sends a pulse (start) via the armature coil 26 to the magnetic circuit and finally to the circuit of the magnetic coil 1. The evaluation electronics 8 recognizes the command as a request to block the door 12 and start the dangerous process in the hazard space. The evaluation electronics thereupon triggers the transistor 2 such that the power supply is connected to the coil circuit. The evaluation electronics in this connection monitors the current rise in the magnetic coil 1. If the current rise corresponds to the almost undelayed current rise of the coil with the magnetic circuit open, the evaluation electronics delivers a signal to the display device which indicates that the door can be properly closed.

If the measured current rise however corresponds to the slow rise with the magnetic circuit closed, the saturated region of the magnet is immediately reached and thus the maximum magnetic force is reached. The door is therefore closed and kept closed. The evaluation electronics 8 indicates this state with the display device. For example, a red light emitting diode blinks. The request to start is relayed at this point to the coordinated control. The latter now starts the dangerous process. With the start a pulse is also sent to the microprocessor 8 which changes the display accordingly. The red light emitting diode for example lights continuously.

While the dangerous process is underway, the evaluation electronics monitors whether the magnet is keeping the door closed. Assuming a worker is gaining access with an expenditure of force, he tears the armature 13 off the magnetic core 3. Via the monitored voltage drop over the measuring resistor 4 the control electronics 15 perceives the current rise which has been induced in the coil circuit by the tearing away of the armature. The microprocessor immediately triggers a stop of the dangerous processes in the hazard space. To achieve this, the coordinated control 17 authorizes the process to be stopped. At the same time the microprocessor initiates an alarm.

If this current rise is not monitored in an alternative version, alternatively the operating state of the magnet is monitored. As long as the securing system is activated, the magnet can be in the saturated region. To monitor this, the microprocessor 8 triggers the transistor 2 such that current supply is interrupted at regular time intervals for a few milliseconds. The induced current change in the coil circuit causes a change of the magnetic field and a current change in the armature coil. The latter is used to supply the armature-side operating and control electronics 20.

During the voltage interruption (FIG. 5 region B) the current in the magnetic coil drops. With the magnetic circuit closed and with a small air gap, the magnet is in the saturated region, the current initially drops quickly, then slowly. For saturated operation and a magnetic circuit with a medium air gap, the current drops slowly. For unsaturated operation the initial current intensity is too low and/or the current drop is much flatter than in saturated operation. For a larger air gap the magnet is in the unsaturated region, the current drops very quickly. For unsaturated operation and an open magnetic circuit the current drop is too steep. The microprocessor recognizes whether the current intensity provided for operation is initially present, and whether the current drop which is typical of closed and saturated operation is being measured. If this should not be the case, the microprocessor triggers a fault case with an alarm and immediate shutdown of the dangerous process.

An exemplary securing means 11, 13, 15 as disclosed is used, in summary, for keeping closed and releasing, as well as monitoring the state of a part which clears or blocks access to a hazard space. The securing means comprises an electromagnet 11 and an armature 13 for closing the magnetic circuit of the electromagnet. Furthermore, the securing means comprises a power supply circuit in which a transistor 2 for connecting a voltage source to the magnetic coil 1 and for separating the voltage source from the magnetic coil 1 and a measuring resistor 4 are present. Furthermore, it comprises an evaluation device 7, 8 for measuring the voltage drop over the measuring resistor 4 and for evaluating this current measurement. Because the measuring resistor 4 is also located in the magnetic coil circuit, a coil current can be measured which occurs simply within the coil circuit. Therefore it can be monitored using this current whether during operation the armature 13 is lifted off the core 3; this induces a current rise in the coil circuit. It can therefore be monitored how the current drop proceeds when the coil 1 is separated from the voltage source. Reliable detection of the state of the securing means is ensured by monitoring the current behavior when the coil 1 is connected to the voltage source and by monitoring the coil circuit for an induced current rise and/or current drop outside of a tolerance region when the voltage source is separated from the coil 1.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

What is claimed is:

1. Securing means for keeping closed and releasing, as well as monitoring the state of a part which clears or blocks access to a hazard space, comprising
an electromagnet and
an armature for closing the magnetic circuit of the electromagnet, and the armature and the electromagnet are located on the access and on the part which clears or blocks the access so that in the position of this part which denies access the magnetic circuit is closed, in the position which clears access the magnetic circuit is however open,
a supply circuit in which there are a switch for connection of the power source to a magnetic coil and for separating the current source from the magnetic coil, and a measuring resistor,
an evaluation device for measuring the voltage drop over a measuring resistor and for evaluating this current measurement,
wherein the measuring resistor is located both in the supply circuit and also in the magnetic coil circuit.

2. The securing means as claimed in claim 1, wherein the evaluation device is connected to the access circuit to a coordinated control for the hazard space and is made for sending information to the access circuit and for receiving information from the access circuit.

3. The securing means as claimed in claim 1, wherein the evaluation device is made to trigger a switch depending on a time measurement, a value or a value difference of current measurement.

4. The securing means as claimed in claim 1, wherein the evaluation device is made to measure the time behavior of the current rise in the magnetic coil circuit when the electromagnet is turned on, especially within the unsaturated operating region of the electromagnet.

5. The securing means as claimed in claim 1, wherein the evaluation device is made to measure the current change during operation of the electromagnet, especially a current rise in the magnetic coil circuit beyond the normal level of the operating current.

6. The securing means as claimed in claim 1, wherein the evaluation device is configured to measure the time behavior of the current drop in the magnetic coil circuit when the supply circuit is interrupted, and for turning on the power supply with the switch after reaching the unsaturated operation region of the electromagnet.

7. The securing means as claimed in claim 1, wherein the core of the electromagnet is built from transformer laminations.

8. The securing means as claimed in claim 1, wherein a coil around the armature and operating electronics connected to this armature coil for input of signals into the magnetic circuit and thus into the magnet coil circuit.

9. The securing means as claimed in claim 1, wherein a coil around the armature and display electronics connected to this armature coil for display of state changes or of the state of the magnetic circuit.

10. The securing means as claimed in claim 1, wherein a mating shape between the armature and the core which differs from a plane.

11. Process for monitoring the state of a part which clears or blocks access to a hazard space with a securing means a claimed in claim 1, in which a change of the voltage drop over the measuring resistor when a supply parameter changes is measured and interpreted, wherein the time behavior of the current intensity which can be monitored only within the magnetic coil circuit is monitored.

12. Process as claimed in claim 11, wherein the time behavior of the current rise in the magnetic coil circuit within unsaturated operation is monitored when the magnetic coil is connected to the supply circuit and it can be deduced from this behavior whether the magnetic circuit is closed or not.

13. Process as claimed in claim 11, wherein based on the measured slopes of the current rise, a boundary value of the magnetic coil current with respect to the saturated and unsaturated operating region of the magnet is determined.

14. Process as claimed in claim 1, wherein the magnetic coil circuit is separated from the power supply at time intervals and in doing so the current drop in the coil circuit is monitored.

15. Process as claimed in claim 14, wherein the power supply is turned on again after a predetermined time interval or as soon as the magnetic coil current drops below a predetermined value.

16. Process as claimed in claim 1, wherein during operation of the electromagnet the current in the magnetic coil circuit is monitored for a rise beyond the normal operating level.

17. Process for monitoring the state of a part which clears or blocks access to a hazard space with a securing means a claimed in claim 9, in which a change of the voltage drop over the measuring resistor when a supply parameter changes is measured and interpreted, wherein the time behavior of the current intensity which can be monitored only within the magnetic coil circuit is monitored.

18. Process as claimed in claim 12, wherein based on the measured slopes of the current rise, a boundary value of the magnetic coil current with respect to the saturated and unsaturated operating region of the magnet is determined.

19. Process as claimed in claim 13, wherein the magnetic coil circuit is separated from the power supply at time intervals and in doing so the current drop in the coil circuit is monitored.

20. Process as claimed in claim 15, wherein during operation of the electromagnet the current in the magnetic coil circuit is monitored for a rise beyond the normal operating level.

21. A securing apparatus for keeping closed and releasing, as well as monitoring a part which clears or blocks access to a hazard space, comprising:
an electromagnet;
an armature for closing a magnetic circuit of the electromagnet, the armature and the electromagnet being disposed such that in a position of this part which denies access the magnetic circuit is closed, and in a position which clears access the magnetic circuit is open;
a supply circuit in which there are a switch for connection of a power source to a magnetic coil and for separating the current source from the magnetic coil, and a measuring resistor; and
an evaluation device for measuring the voltage drop over a measuring resistor and for evaluating this current measurement.
